(19) United States
(12) Patent Application Publication
(10) Pub. No.: US 2026/0246119 A1
(43) Pub. Date: Aug. 20, 2026

(54) SECONDARY BATTERY

(71) Applicant: SAMSUNG SDI CO., LTD., Yongin-si (KR)

(72) Inventors: Siyoung LEE, Yongin-si (KR); Gukhyung LEE, Yongin-si (KR)

(21) Appl. No.: 19/295,841

(22) Filed: Aug. 11, 2025

(30) Foreign Application Priority Data
Feb. 20, 2025 (KR) 10-2025-0022198

(51) Int. Cl. H01M 50/583; H01M 50/533

(52) U.S. Cl. CPC H01M 50/583; H01M 50/533

(57) ABSTRACT

A secondary battery includes a case have an open upper end and an electrode assembly accommodated in the case, with the electrode assembly including a substrate tab. A current collector plate connected to the substrate tab, and a current interrupt device is positioned on the current collector plate and coupled with the upper end of the case. The current collector plate includes a first fastening portion on the upper surface of the current collector plate that faces the current interrupt device. The current interrupt device includes a second fastening portion on the lower surface of the current interrupt device that faces the current collector plate. The current interrupt device is coupled to the current collector plate by fastening between the first fastening portion and the second fastening portion.

### CROSS-REFERENCE TO RELATED APPLICATIONS

This present application claims priority to and the benefit under 35 U.S.C. § 119(a)-(d) of Korean Patent Application No. 10-2025-0022198, filed on February 20, 2025, in the Korean Intellectual Property Office, the entire disclosure of which is incorporated herein by reference.

### BACKGROUND

### FIELD

The present disclosure relates to a secondary battery.

### DESCRIPTION OF RELATED ART

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

A current collector plate of the secondary battery functions to deliver current generated in an electrode to an external circuit. The current collector plate is formed of a conductive metal and is designed to be thin and uniform in order to minimize electrical resistance and to maintain strong bonding with an electrode material. The current collector plate is required to to provide sufficient energy density and thermal management performance of the battery.

A current interrupt device (CID) is a safety device for a secondary battery that interrupts a circuit when internal pressure rises, over-charging occurs, or an over-current situation occurs. A CID thereby prevents risks such as thermal runaway. The CID operates by physically interrupting current through deformation of a metal disc or by breaking an electrical circuit. Thus, a CID improves reliability and safety of a battery.

When the current collector plate and the current interrupt device are connected using a tab in the secondary battery, there is considerable room for improvement in terms of energy density, conduction stability, internal resistance, and quality management of the battery.

The above information disclosed in this Background section is for enhancement of understanding of the background of the present disclosure, and therefore, it may contain information that does not constitute related (or prior) art.

### SUMMARY

An object to be solved by the present disclosure is to provide a secondary battery that addresses the above-described problems.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

In accordance with one embodiment of the present disclosure, a secondary battery includes a case having an open upper end, and an electrode assembly accommodated in the case, the electrode assembly including a substrate tab, and a current interrupt device (CID) on the current collector plate, the current interrupt device being coupled to the upper end of the case. The current collector plate includes a first fastening portion on an upper surface of the current collector plate that faces the current interrupt device. The current interrupt device includes a second fastening portion on a lower surface of the current interrupt device that faces the current collector plate. The current interrupt device is coupled to the current collector plate by fastening between the first fastening portion and the second fastening portion.

According to one embodiment of the present disclosure, the first fastening portion may include a groove recessed downward, and the second fastening portion includes a protrusion protruding downward.

According to one embodiment of the present disclosure, the first fastening portion may include a protrusion protruding upward, and the second fastening portion may include a groove recessed upward.

According to one embodiment of the present disclosure, a first hole is formed at a center of the current collector plate and a second hole is formed in the current collector plate at a first distance from the center, and the first fastening portion may be positioned at a second distance from the center, the second distance is shorter than the first distance.

According to one embodiment of the present disclosure, the current collector plate may further include a connection region to which the substrate tab is connected, and the first fastening portion may be alternately disposed with the connection region about the first hole.

According to one embodiment of the present disclosure, the first fastening portion and the second fastening portion may have one of a circular, elliptical, or polygonal cross-sectional shape, and the cross-sectional shapes of the first fastening portion and the second fastening portion correspond to each other.

According to one embodiment of the present disclosure, the second fastening portion may have an annular shape positioned along a circumference in a lowermost surface of the current interrupt device, and the first fastening portion may have a shape corresponding to the second fastening portion.

According to one embodiment of the present disclosure, a surface area of a lower surface of the protrusion may be 1% to 50% of a surface area of a lowermost surface of the current interrupt device.

According to one embodiment of the present disclosure, a surface area of an upper surface of the protrusion may be 1% to 50% of a surface area of an upper surface of the current collector plate.

In accordance with one embodiment of the present disclosure for solving the technical problem, a secondary battery includes a case having an open upper end, an electrode assembly accommodated in the case, the electrode assembly including a substrate tab, a current collector plate connected to the substrate tab, and a current interrupt device on the current collector plate, the current interrupt device being coupled to the upper end of the case. The current collector plate includes a first contact portion on an upper surface of the current collector plate that faces the current interrupt device. The current interrupt device includes a second contact portion on a lower surface of the current interrupt device that faces the current collector plate. A surface of the first contact portion contacts a surface of the second contact portion such that the current collector plate and the current interrupt device are electrically connected.

According to one embodiment of the present disclosure, the first contact portion may include a flat portion in the same plane as the upper surface of the current collector plate, and the second contact portion may include a protrusion protruding downward.

According to one embodiment of the present disclosure, the first contact portion may include a protrusion protruding upward, and the second contact portion may include a flat portion in the same plane as a lowermost surface of the current interrupt device.

According to one embodiment of the present disclosure, the first contact portion may include a protrusion protruding upward, and the second contact portion may include a protrusion protruding downward.

According to one embodiment of the present disclosure, a first hole is formed at a center of the current collector plate and a second hole is formed in the current collector plate at a first distance from the center, and the first contact portion may be at a second distance from the center, the second distance is shorter than the first distance.

According to one embodiment of the present disclosure, the current collector plate may further include a connection region to which the substrate tab is connected, and the first contact portion may be alternately disposed with the connection region about the first hole.

According to one embodiment of the present disclosure, the protrusion may have one of a circular, elliptical, or polygonal cross-sectional shape.

According to one embodiment of the present disclosure, the second contact portion may have an annular shape positioned along a circumference of a lowermost surface of the current interrupt device, and the first contact portion may have a shape corresponding to the second contact portion.

According to one embodiment of the present disclosure, the substrate tab may be exposed to an upper surface of the electrode assembly. The substrate tab may be bent toward a center of the electrode assembly. The substrate tab may be connected to a lower surface of the current collector plate.

According to one embodiment of the present disclosure, the current interrupt device may include an upper cap including a terminal portion protruding upward, a vent below the upper cap and configured to burst when an internal pressure of the case exceeds a threshold value to release gas from inside the case, and a lower cap below the vent. The lower surface of the current interrupt device that faces the current collector plate may correspond to a lower surface of the lower cap.

According to one embodiment of the present disclosure, the secondary battery may further include a conduction-activating member interposed between the current collector plate and the current interrupt device. The conduction-activating member may include a conductive powder, a tape containing a conductive powder, or a combination of a conductive powder and a tape containing a conductive powder.

According to embodiments of the present disclosure, a tab for electrically connecting the current-collector plate to the current interrupt device in a secondary battery can be omitted, by fastening a first fastening portion of a current collector plate to a second fastening portion of a current-interrupt device or by bringing a first contact portion of the current collector plate into contact with the second contact portion of the current interrupt device.

According to embodiments of the present disclosure, the energy density and/or capacity of the battery can be increased by omitting a tab for electrically connecting the current-collector plate to the current interrupt device.

According to embodiments of the present disclosure, the omission of the tab also eliminates welding or other joining processes for the current collector plate and the current interrupt device, thereby improving manufacturing efficiency.

According to embodiments of the present disclosure, by removing those welding processes, electrical short-circuit phenomena can be prevented.

According to embodiments of the present disclosure, the mechanical fastening reliability and the electrical conduction reliability between the current-collector plate and the current interrupt device can be enhanced by the fastening portion and the contact portion.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1 is a perspective view of a secondary battery according to an embodiment.

FIG. 2 is a first example of a connection manner between a current collector plate and a current interrupt device.

FIG. 3 is a second example of a connection manner between a current collector plate and a current interrupt device.

FIG. 4 is a view of a current collector plate and a current interrupt device according to an embodiment of the present disclosure.

FIG. 5 is a view of a connection manner between a substrate tab and a current collector plate according to an embodiment of the present disclosure.

FIG. 6 is a view of a connection manner between a current collector plate and a current interrupt device according to an embodiment of the present disclosure.

FIG. 7 is a view of a connection manner between a current collector plate and a current interrupt device according to an embodiment of the present disclosure.

FIG. 8 is a view of a connection manner between a current collector plate and a current interrupt device according to an embodiment of the present disclosure.

FIG. 9 is a view of a connection manner between a current collector plate and a current interrupt device according to an embodiment of the present disclosure.

FIG. 10 is a view of a current collector plate and a current interrupt device according to an embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being "on," "connected to," or "coupled to" another element or layer, it may be directly on, connected, or coupled to the other element or layer or one or more intervening elements or layers may also be present. When an element or layer is referred to as being "directly on," "directly connected to," or "directly coupled to" another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term "and/or" includes any and all combinations of one or more of the associated listed items. Further, the use of "may" when describing embodiments of the present disclosure relates to "one or more embodiments of the present disclosure." Expressions, such as "at least one of" and "any one of," when preceding a list of elements, modify the entire list of elements and do not modify the individual elements of the list. When phrases such as "at least one of A, B and C, "at least one of A, B or C," "at least one selected from a group of A, B and C," or "at least one selected from among A, B and C" are used to designate a list of elements A, B and C, the phrase may refer to any and all suitable combinations or a subset of A, B and C, such as A, B, C, A and B, A and C, B and C, or A and B and C. As used herein, the terms "use," "using," and "used" may be considered synonymous with the terms "utilize," "utilizing," and "utilized," respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as "beneath," "below," "lower," "above," "upper," and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as "below" or "beneath" other elements or features would then be oriented "above" or "over" the other elements or features. Thus, the term "below" may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms "a" and "an" are intended to include the plural forms as well, unless the context clearly indicates otherwise. It will be further understood that the terms "includes," "including," "comprises," and/or "comprising," when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being "the same" may mean that they are "substantially the same". Thus, the phrase "substantially the same" may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element "above (or below)" or "on (under)" another element may mean that the arbitrary element may be disposed in contact with the upper (or lower) surface of the element, and another element may also be interposed between the element and the arbitrary element disposed on (or under) the element.

In addition, it will be understood that when a component is referred to as being "linked," "coupled," or "connected" to another component, the elements may be directly "coupled," "linked" or "connected" to each other, or another component may be "interposed" between the components".

Throughout the specification, when "A and/or B" is stated, it means A, B or A and B, unless otherwise stated. That is, "and/or" includes any or all combinations of a plurality of items enumerated. When "C to D" is stated, it means C or more and D or less, unless otherwise specified.

The terminology used in the present specification is for the purpose of illustrating embodiments of the present disclosure and is not intended to limit the present disclosure.

In the present disclosure, sizes and relative sizes of layers and regions illustrated in the drawings may be exaggerated for clarity of description. That is, the sizes illustrated in the drawings are merely for ease of understanding and are not limiting. Also, the same reference numerals throughout the entire specification may denote the same constituent elements.

Although the present disclosure is described by taking, as an example, a case where the secondary battery is a cylindrical battery, the present disclosure is not limited thereto. In embodiments, the secondary battery may be, for example, a cylindrical, coin-type, pin-type, prismatic, or pouch-type secondary battery having other external shapes.

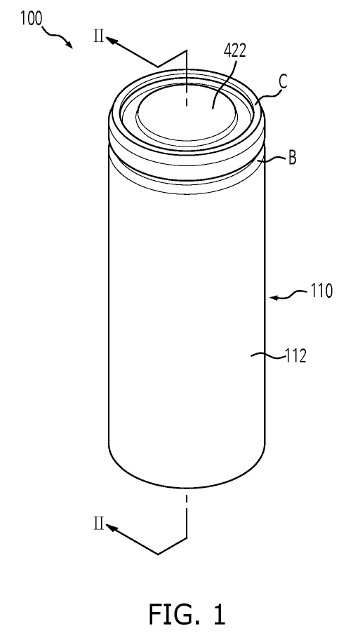

FIG. 1 is a perspective view of a secondary battery according to an embodiment.

A secondary battery 100 according may include an electrode assembly. A case 110 that accommodates the electrode assembly and includes an opening on an upper end, a current collector plate, and a current interrupt device (CID). The electrode assembly may include a first electrode, a second electrode, and a separator interposed between the first electrode and the second electrode. The electrode assembly may be a wound-type electrode assembly in which the first electrode, the second electrode, and the separator are wound. In other embodiments, the electrode assembly may be a stacked-type electrode assembly in which the first electrode, the second electrode, and the separator are alternated in a stack. For example, the electrode assembly may be a wound-type electrode assembly formed by winding a first electrode, a separator, and a second electrode.

The first electrode may include a first base and a first active material layer disposed on the first base. A first substrate tab may extend outward from a first uncoated portion of the first base where the first active material layer is not provided. The first substrate tab may be electrically connected to the current collector plate and the current interrupt device.

The second electrode may include a second base and a second active material layer disposed on the second base. A second substrate tab may extend outward from a second uncoated portion of the second base where the second active material layer is not provided. The second substrate tab may be electrically connected to the case 110. The first substrate tab and the second substrate tab may extend in opposite directions from the electrode assembly, and the first substrate tab and the second substrate tab may be bent at predetermined positions. In another example, the first substrate tab and the second substrate tab may extend in the same direction relative to the electrode assembly.

The first electrode may function as a positive electrode. In such an embodiment, the first base may be formed, for example, of an aluminum foil, and the first active material layer may include a positive active material such as a transition-metal oxide. The first active material layer may further include a conductive material or a binder. The second electrode may function as a negative electrode. In such an embodiment, the second base may be formed, for example, of a copper foil or a nickel foil, and the second active material layer may include a negative active material such as graphite. The second active material layer may further include a conductive material or a binder. In another example, the first electrode may function as the negative electrode and the second electrode may function as the positive electrode.

The separator may allow movement of ions while preventing short-circuiting between the first electrode and the second electrode. The separator may be formed of, for example, a polyethylene film, a polypropylene film, or a polyethylene-polypropylene film.

The case 110 may accommodate the electrode assembly and an electrolyte therein. Together with the current interrupt device, the case 110 may form an exterior of the secondary battery 100. The case 110 may include the opening in the upper end, and the current interrupt device may be coupled to the opening. The case 110 may include a body 112 that is approximately cylindrical and a bottom connected to one side of the body 112. A beading portion B that protrudes inward may be positioned in the body 112, and a crimping portion C that is bent inward may be at an end of the body 112 on the open side.

The beading portion B may suppress movement of the electrode assembly inside the case 110 and may facilitate seating of the current interrupt device. The crimping portion C may press an edge of the current interrupt device via a gasket so as to firmly fix the current interrupt device. The case 110 may be formed of a metallic material, for example, steel plated with nickel.

The current interrupt device may be coupled to an inner side of the crimping portion C via the gasket to seal the open end of the case 110. An upper cap 422 may be at an uppermost side of the current interrupt device. The upper cap 422 may protrude convexly upward and may include a terminal portion that is to be connected to an external circuit. The current interrupt device may be a safety device that, when operating during an abnormal situation in the secondary battery, protects the secondary battery by interrupting a circuit. The current interrupt device may be configured to operate when specific conditions such as temperature, pressure, or current exceed threshold values. For example, the current interrupt device may be configured to interrupt the circuit by deformation of a metal structure due to various factors such as an increase of internal pressure, over-charging, over-heating, over-current, or an initial stage of thermal runaway of the secondary battery.

The current collector plate may be connected to the substrate tab. The current collector plate may be plate-shaped and may function to collect current from the electrode assembly. In an embodiment, a first uncoated portion of the first electrode and a second uncoated portion of the second electrode may be on opposite sides. In such an embodiment, the current collector plate may include a first current collector plate and a second current collector plate, with the first current collector plate connected to the first uncoated portion of the first electrode and the second current collector plate connected to the second uncoated portion of the second electrode. The case 110 may be connected to either the first current collector plate or the second current collector plate. In an example, the case 110 may be connected to the first current collector plate and may function as a first electrode terminal in the secondary battery 100.

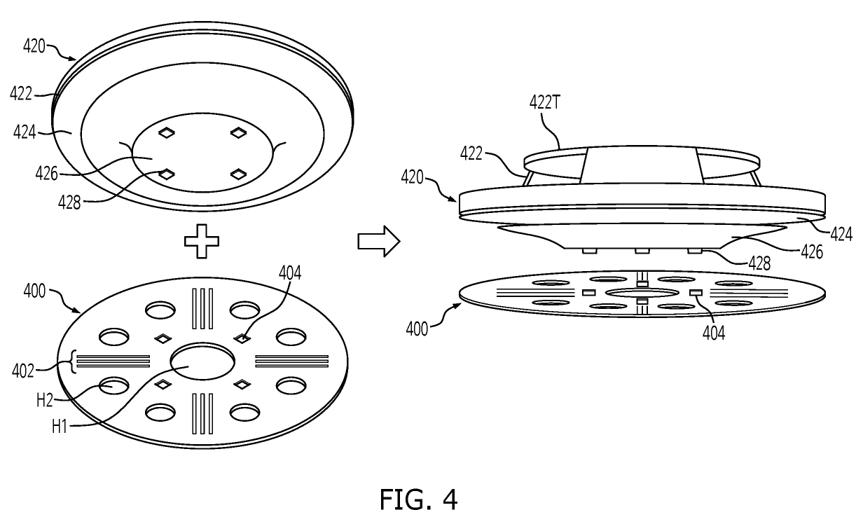

Specific features of the current collector plate and the current interrupt device will be described below with reference to FIGS. 4 to 10.

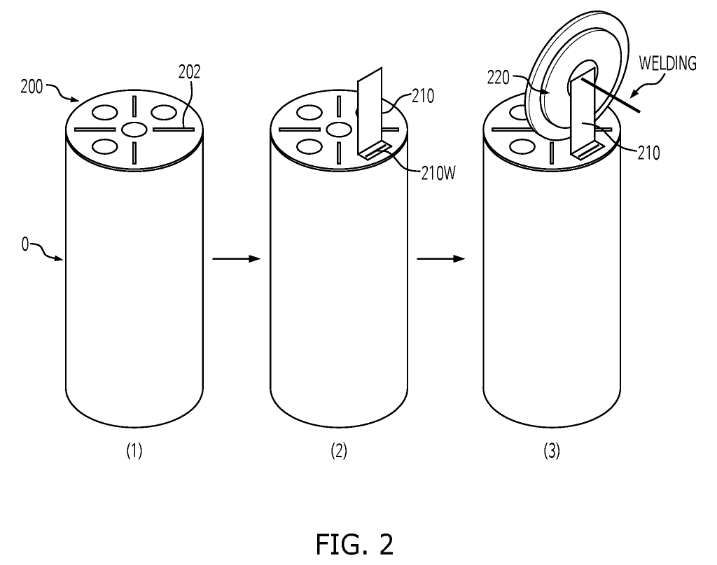

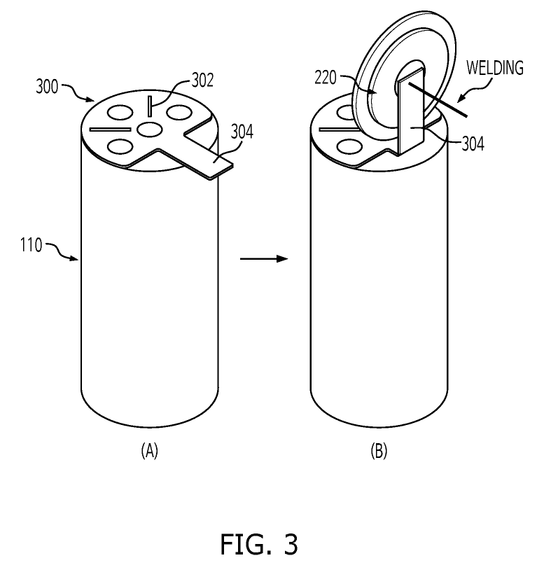

FIG. 2 is a first example of a connection manner between the current collector plate and the current interrupt device. FIG. 3 is a second example of a connection manner between the current collector plate and the current interrupt device. FIGS. 2 and 3 illustrate methods of electrically connecting a current collector plate 200, 300 and a current interrupt device 220 to an electrode assembly accommodated in the case 110. In FIGS. 2 and 3, portions above the current collector plate 200, 300 are omitted\.

Referring to FIG. 2(1), a substrate tab of the electrode assembly accommodated in the case 110 may be connected to a lower surface of the current collector plate 200. In particular, a substrate tab of the electrode assembly may be connected to the lower surface of the current collector plate 200 that faces the electrode assembly. The connection between the substrate tab and the current collector plate 200 may be, for example, laser-welding, ultrasonic-welding, resistance-welding, spot-welding, or soldering, which facilitate current conduction between the substrate tab and the current collector plate 200. A connection region 202 with the substrate tab may be on an upper surface of the current collector plate 200, for example, the upper surface of the current collector plate 200 that faces the current interrupt device 220. The region 202 with the substrate tab may denote a bead formed by laser-welding or a region corresponding to a portion connected to the substrate tab on the lower surface of the current collector plate 200.

Referring to FIG. 2(2), a tab 210 may be used to connect the current collector plate 200 to the current interrupt device 220. A first end of the tab 210 may be connected to a region of the upper surface of the current collector plate 200 where a hole for gas release or the connection region 202 is not positioned. By connecting one end of the tab to the upper surface of the current collector plate, a connection portion 210W may be formed. The connection between the current collector plate and the tab may be, for example, laser-welding, ultrasonic-welding, resistance-welding, spot-welding, or soldering. The connection portion may correspond to, for example, a welding portion.

Referring to FIG. 2(3), a second end of the tab 210 may be connected to the current interrupt device 220. The second end of the tab 210 may be connected to a lower surface of the current interrupt device 220, for example, the lower surface of the current interrupt device 220 that faces the current collector plate 200 in the secondary battery. The connection of the tab 210 may be, for example, laser-welding, ultrasonic-welding, resistance-welding, spot-welding, or soldering. The tab 210 may be bent during an assembly process of the secondary battery.

When the current collector plate 200 and the current interrupt device 220 are connected using the tab 210, a process of connecting the tab 210 to the current collector plate 200 and a separate process of connecting the tab 210 to the current interrupt device 220 may be performed. Because there are two processes, the manufacturing efficiency may decrease. Further, when the connection between the current collector plate 200 and the tab 210 and the connection between the tab 210 and the current interrupt device 220 are welding connections, quality variation of the battery may occur due to minute changes of welding conditions. And welding debris may cause an electrical short in the case 110. Accordingly, a step such as a welding inspection may be added to reduce welding defects. Still further, when the current collector plate 200 and the current interrupt device 220 are connected using the tab 210, a space may be required between the current collector plate 200 and the current interrupt device 220, and thus energy density of the battery may decrease.

Referring to FIG. 3(A), electrode assembly accommodated in the case 110 is shown as in FIG. 2(1), except that a shape of a current collector plate 300 is different from that of the current collector plate 200 A connection region 302 with the substrate tab may be a bead formed by laser-welding with the substrate tab or a region corresponding to a portion connected to the substrate tab on the lower surface of the current collector plate 300. As illustrated in FIG. 3(A), the current collector plate 300 according to the second example may have a structure in which one side of the current collector plate 300 is extended and a tab 304 is integrally connected.

Referring to FIG. 3(B), the tab 304 of the current collector plate 300 may be folded upward and connected to the current interrupt device 220. The connection method may be the same as that described with reference to FIG. 2(3). The tab 304 may be bent during a process of assembling the secondary battery.

Even when the tab 304 is integrally formed with the current collector plate 300, manufacturing process efficiency may decrease because of the performance of the process of connecting the tab 304 to the current interrupt device 220. And, when welding is used to connect the tab 304 and the current interrupt device 220, quality of the battery may vary or an electrical short may occur due to poor welding quality. Accordingly, a step such as a welding inspection may be added, and the energy density of the battery may decrease due to the space required for the integral tab 304.

Hereinafter, a modified structure of the current collector plate and the current interrupt device for solving the above-described problems will be described.

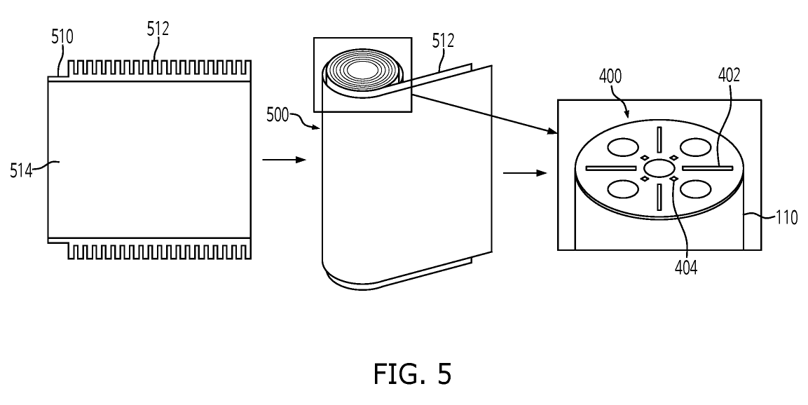

FIG. 4 is a view of a current collector plate and a current interrupt device according to an embodiment of the present disclosure. FIG. 5 is a view of a connection manner between a substrate tab and a current collector plate according to an embodiment of the present disclosure.

A current collector plate 400 according to an embodiment may be on the electrode assembly accommodated in the case and may be connected to a substrate tab of the electrode assembly as described above with reference to FIGS. 2 and 3. As illustrated in FIG. 4, a connection region 402 with the substrate tab of the current collector plate 400 may be positioned in a direction crossing a central portion and a peripheral portion of the current collector plate 400 so as to optimize a current path and conduction stability. The connection region 402 may be spaced at predetermined intervals and may be evenly disposed over the current collector plate 400. In the example illustrated in FIG. 4, the connection region 402 is configured as four connection regions that surround the central portion and are spaced at predetermined intervals. Each connection region 402 may have a stripe pattern. However, the number and arrangement of the connection regions 402 are not limited to the depicted embodiment.

Still referring to FIG. 4, a current interrupt device 420 according to an embodiment may be on the current collector plate 400 and may be coupled to the opening of the case so as to form an exterior of the secondary battery. The current collector plate 400 may include a first fastening portion 404 on an upper surface of the current collector plate 400 that faces the current interrupt device 420. The current interrupt device 420 may include a second fastening portion 428 on a lower surface that faces the current collector plate 400. By fastening the first fastening portion 404 and the second fastening portion 428, the current interrupt device 420 may be coupled to the current collector plate 400.

The fastening between the first fastening portion 404 and the second fastening portion 428 in an assembly process of the current interrupt device 420 by applying pressure so that a protrusion enters a groove. Specifically, the first fastening portion 404 may include a groove recessed downward, and the second fastening portion 428 may include a protrusion protruding downward. A direction in which the groove is recessed downward may be the same as a direction in which the protrusion of the second fastening portion 428 protrudes downward such that fastening between the current collector plate 400 and the current interrupt device 420 may be achieved. The direction in which the groove is recessed downward may be, for example, toward the electrode assembly from the current collector plate 400.

A thickness of the current collector plate may be about 0.1 mm to 0.5 mm. In such embodiments, a recessed depth of the groove may be greater than 0 mm and less than or equal to 0.45 mm. When the recessed depth of the groove is greater than 0.45 mm, tolerance control of the groove may be difficult. And, since a remaining thickness of the current collector plate is about 0.05 mm, there may be an increased possibility of deformation of the current collector plate.

When the thickness of the current collector plate is about 0.1 mm to 0.5 mm, a length of the protrusion may be 0.1 mm to 10 mm. When the length of the protrusion is less than 0.1 mm, the fixing by fastening the protrusion may be weak. When the length of the protrusion is greater than 10 mm, a total height of the battery may become too large, and the current collector plate may be difficult to manufacture through a simple process such as punching, chemical etching, roll processing, or laser processing.

The thickness of the current collector plate is not limited to the above-described ranges And the recessed depth of the groove and the length of the protrusion may be proportionally changed according to the thickness of the current collector plate or a thickness of a cap-down of the current interrupt device.

In some embodiments, a surface area of a lower surface of the protrusion may be 1% to 50% of a surface area of a lowermost surface of the current interrupt device 420. The surface area of the lower surface of the protrusion may correspond to a surface area of a surface that contacts the current collector plate 400 by being fastened to the first fastening portion 404, that is, the groove. The surface area of the lowermost surface of the current interrupt device 420 may correspond to a surface area of a surface positioned lowermost in the current interrupt device 420. For example, the surface area may correspond to a surface area of a lower surface of a lower cap 426 that is a lowermost surface of the current interrupt device 420. When the surface area of the lower surface of the protrusion is less than 1% of the surface area of the lowermost surface of the current interrupt device 420, a fastening effect may decrease and conduction may not be smooth such that performance and/or lifespan of the battery may deteriorate. When the surface area of the lower surface of the protrusion is greater than 50 % of the surface area of the lowermost surface of the current interrupt device 420, an area for connection (e.g., welding) with the substrate tab of the electrode assembly may be too reduced, thereby affecting characteristics of the battery.

Referring to FIG. 4, the current collector plate 400 according to an embodiment may include a first hole H1 at a center of the current collector plate 400 and a second hole H2 at a first distance from the center. In this case, the first fastening portion 404 may be at a second distance from the center, and the second distance may be shorter than the first distance. That is, since the first fastening portion 404 is disposed inside of the second hole H2 with respect to the center of the current collector plate 400, fastening between the current collector plate 400 and the current interrupt device 420 may be reliably achieved. Also, gas release and/or electrolyte injection through the second hole H2 may not be hindered by the fastening between the current collector plate 400 and the current interrupt device 420.

The first hole H1 at the center of the current collector plate 400 may be positioned at an approximate center of the current collector plate 400 and may be positioned to correspond to a winding core of the electrode assembly in an assembled state of the secondary battery. TA winding-core post for connecting the case and bases of electrodes of the electrode assembly may be inserted through the first hole H1.

A plurality of second holes H2 may be positioned around the center of the current collector plate 400. However, the present disclosure is not limit with respect to the number of the second holes H2. The second hole(s) H2 may form a passage through which gas generated in the electrode assembly is released and/or a passage through which electrolyte is injected into an interior of the case. A size of the second hole H2 may be smaller than a size of the first hole H1.

In the current collector plate 400 according to the embodiment as illustrated in FIG. 4, the first fastening portion 404 may be alternately disposed with the connection region 402 about the first hole H1. By preventing an overlap between the connection region 402 and the first fastening portion 404, connection between the substrate tab and the current collector plate 400 and fastening between the current collector plate 400 and the current interrupt device 420 is facilitated. For example, path for conduction through the connection region 402 may not be hindered by the first fastening portion 404. Further, since the connection region 402 and the first fastening portion 404 are alternately disposed, conduction through the connection region 402 may be evenly distributed in the current collector plate 400 while fastening between the current interrupt device 420 and the current collector plate 400 is stable. However, arrangement of the connection region 402 and the first fastening portion 404 is not necessarily limited to an alternate arrangement as depicted in FIG. 4. Various arrangements that can secure stable conduction through the connection region 402 and stably fasten the current collector plate 400 and the current interrupt device 420 may be adopted.

The current interrupt device according to an embodiment may include an upper cap 422 that includes an upwardly protruded terminal portion 422T. The current interrupt device may also include vent 424 below the upper cap 422, with the vent 424 being configured to burst when an internal pressure of the case exceeds a threshold value so as to release gas inside the case. And the current interrupt device may include a lower cap 426 below the vent 424.

The upper cap 422 may be at an uppermost side of the current interrupt device 420. The upper cap 422 may protrude convexly upward and may include the terminal portion 422T to be connected to an external circuit. In addition, an outlet for releasing gas may be positioned around the terminal portion 422T in the upper cap 422.

The vent 424 may be below the upper cap 422. The vent 424 may include a portion protruding convexly downward and at least one notch formed around the protruding portion. When gas is generated inside the secondary battery (e.g., because of over-charging or abnormal operation), the protruding portion of the vent 424 may be deformed upward by gas pressure and separated from the lower cap 426 or the current collector plate 400. The vent 424 may be severed along the notch, and the severed vent 424 may release gas to outside of the secondary battery so as to prevent explosion or fire.

The lower 426 may be below the vent 424. A first through-hole for exposing the protruding portion of the vent 424 and a second through-hole for gas release may be formed in the cap-down 426.

The current interrupt device 420 is not limited to the above-described structure. Rather, the current interrupt device 420 may be configured in various other ways and have various modified structures. For example, the current interrupt device 420 may include the upper cap 422, the vent 424, the lower cap 426, an insulating member (not illustrated) that insulates the vent and the lower cap 426, and a sub-plate (not illustrated) on a lower surface of the lower cap 426.

The sub-plate may be disposed below the lower cap 426. The sub-plate may be coupled to a lower surface of the lower cap 426 so as to close the first through-hole formed in the lower cap 426, and the protruding portion of the vent 424 may be coupled to the sub-plate. The substrate tab of the electrode assembly may be coupled to the sub-plate. Accordingly, the upper cap 422, the vent 424, the lower cap 426, and the sub-plate may be electrically connected to an electrode of the electrode assembly.

In the current interrupt device 420, a lower surface that faces the current collector plate 400 may correspond to a lower surface of the lower cap 426. The lower surface that faces the current collector plate 400 in the current interrupt device 420 may be a lowermost surface of the current interrupt device and the second fastening portion may be positioned on the lower surface. The lower surface that faces the current collector plate 400 in the current interrupt device 420 may vary according to a structure of the current interrupt device 420. For example, the lower surface may correspond to a lower surface of the sub-plate (not illustrated).

In various embodiments, the first fastening portion 404 and the second fastening portion 428 have circular, elliptical, or polygonal cross-sections, and cross-sectional shapes of the first fastening portion 404 and the second fastening portion 428 may correspond to each other. For example, when a cross-section of the first fastening portion 404 is circular, a cross-section of the second fastening portion 428 may be circular. Thus, fastening between the first fastening portion 404 and the second fastening portion 428 may be smooth.

A secondary battery according to an embodiment may further include a conduction-activating member interposed between the current collector plate 400 and the current interrupt device 420. The conduction-activating member may be a coating agent containing a conductive powder, a tape containing a conductive powder, or a combination thereof. The conductive powder may be metal, graphite, carbon black, etc., but the present disclosure is not limited to these examples. The metal may be nickel, copper, aluminum, silver, etc., but is not limited thereto, and any conductive metal may be used.

With the conduction-activating member interposed between the current collector plate 400 and the current interrupt device 420, conduction between the current interrupt device and the current collector plate may be activated. The conduction-activating member may be applied or attached to a surface of the first fastening portion 404 or the second fastening portion 428 and may be interposed between the current collector plate 400 and the current interrupt device 420.

Referring to FIG. 5, a substrate tab 512 may be exposed from an upper surface of an electrode assembly 500, may be bent toward a center of the electrode assembly, and may be connected (e.g., welded) to a lower surface of the current collector plate.

The substrate tab 512 may be formed by notching an uncoated portion where an active material layer 514 is not provided on a base 510, and a plurality of substrate tabs 512 may be formed as illustrated in FIG. 5. By notching the uncoated portion to form the substrate tab 512, a pressing process of flattening or closely attaching the substrate tab 512 to increase reliability of connection (e.g., welding) between the substrate tab 512 and the current collector plate 400 may be easily performed. By pressing the substrate tab, a degree of close contact of the substrate tab 512 is improved such that a contact area may increase and internal resistance may decrease when the substrate tab 512 is connected to the current collector plate 400. When the pressing is uniform, quality of connection through the connection region 402 between the current collector plate 400 and the substrate tab 512 may be improved.

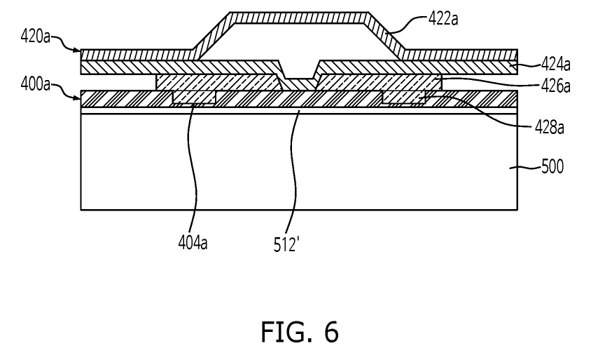

FIGS. 6 to 9 are views of connections between a current collector plate and a current interrupt device according to embodiments of the present disclosure. More specifically, FIGS. 6 to 9 are cross-sectional schematic views of fastening or contact portions of the current collector plate and the current interrupt device. A base-tab pressed portion 512' may correspond to a portion where a plurality of substrate tabs (e.g., 512 of FIG. 5) are flattened or closely attached by a pressing process. The base-tab pressed portion 512' may be on an upper surface of the electrode assembly 500 (e.g., an upper surface of the electrode assembly that faces the current collector plate).

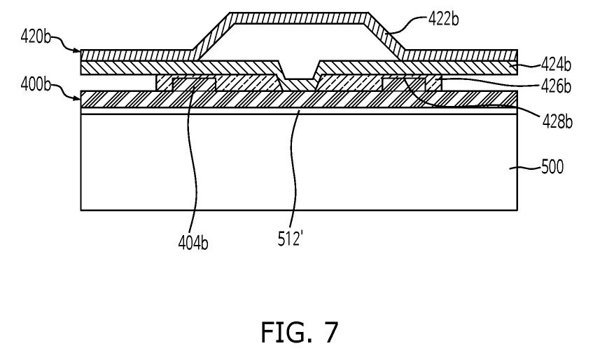

The upper cap 422a and the vent 424a in FIG. 6 correspond to upper caps 422b to 422d and vents 424b to 424d in FIGS. 7 to 9. The lower cap 426a and a current collector plate 400a in FIG. 6 differ from the lower caps 426b to 426d and current collector plates 400b to 400d in FIGS. 7 to 9 with respect to configurations of a first fastening portion, a second fastening portion, a first contact portion, or a second contact portion.

Referring to FIG. 6,, a first fastening portion 404a may include a groove recessed downward, and a second fastening portion 428a may include a protrusion protruding downward. The direction the groove is recessed downward may be the same the direction that the protrusion protrudes downward. Thus, the protrusion of the current interrupt device 420a may be fastened in the groove of the current collector plate 400a by pressure or the like.

Referring to FIG. 7, a first fastening portion 404b may include a protrusion protruding upward, and a second fastening portion 428b may include a groove recessed upward. The direction the groove is recessed upward may be the same that direction that the protrusion protrudes upward. Thus, the protrusion of the current interrupt device 420b may be fastened in the groove of the current collector plate 400b by pressure or the like.

A surface area of an upper surface of the protrusion may be 1 % to 50 % of a surface area of an upper surface of the current collector plate 400b. The surface area of the upper surface of the protrusion may correspond to a surface area that contacts the current interrupt device 420b by being fastened with the groove. The surface area of the upper surface of the current collector plate 400b may correspond to a surface area of an upper surface of the current collector plate 400b that faces the current interrupt device 420b. When the surface area of the upper surface of the protrusion is less than 1 % of the surface area of the upper surface of the current collector plate 400b, a fastening force may decrease and conduction may not be smooth such that performance and/or lifespan of the battery may deteriorate. When the surface area of the upper surface of the protrusion is greater than 50 % of the surface area of the upper surface of the current collector plate 400b, an area for connection (e.g., welding) with the substrate tab of the electrode assembly may be too reduced, thereby affecting characteristics of the battery.

The protruded length of the protrusion and the recessed depth of the groove may be substantially the same as those described above with reference to FIG. 4.

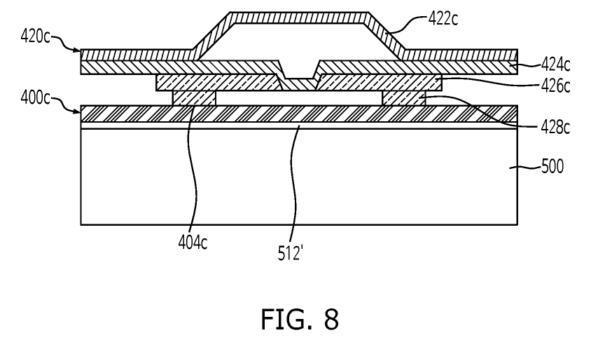

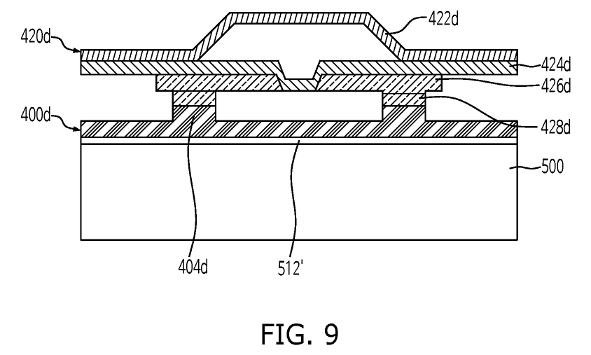

Referring to FIGS. 8 and 9, in other embodiments, current collector plates 400c, 400d may include first contact portions 404c, 404d positioned on upper surfaces of the current collector plates 400c, 400d that face current interrupt devices 420c, 420d. The current interrupt devices 420c, 420d may include second contact portions 428c, 428d on lower surfaces of the current interrupt devices 420c, 420d that face the current collector plates 400c, 400d. The first contact portions 404c, 404d and the second contact portions 428c, 428d may contact each other so that the current collector plates 400c, 400d and the current interrupt devices 420c, 420d are electrically connected.

Unlike conduction and fixing effects between the current collector plate and the current interrupt device resulting from fastening between the first fastening portion and the second fastening portion described above with reference to FIGS. 4 to 7, conduction effects between the current collector plate 400c, 400d and the current interrupt device 420c, 420d may be obtained by surface-to-surface contact between the first contact portions 404c, 404d and the second contact portions 428c, 428d. The current collector plates 400c,400d may be connected to the base-tab pressed portion 512'. The current interrupt devices 420c,420d may be crimped to the case via the gasket. Thus, in an assemble secondary battery, the first contact portions 404c, 404d and the second contact portions 428c, 428d may be aligned and fixed so as to face each other, and the current collector plates 400c, 400d and the current interrupt devices 420c, 420d may be electrically connected.

Referring to FIG. 8, the first contact portion 404c may include a flat portion on the same plane as an upper surface of the current collector plate 400c, and the second contact portion 428c may include a protrusion protruding downward. A direction that the protrusion protrudes downward may be the same as a direction toward the electrode assembly or toward the flat portion. Thus, in an assembled state of the secondary battery, the protrusion may reliably contact the flat portion in a surface-to-surface manner such that the current collector plate 400c and the current interrupt device 420c are electrically connected. A length of the protrusion and a surface area of an upper surface or a lower surface of the protrusion may be substantially the same as those described above with reference to FIG. 4.

Although not illustrated, in another example the first contact portion may include a protrusion protruding upward, and the second contact portion may include a flat portion on the same plane as a lowermost surface of the current interrupt device.

Referring to FIG. 9, the first contact portion 404d may include a protrusion protruding upward, and the second contact portion 428d may include a protrusion protruding downward. A direction in which the protrusion of the first contact portion 404d protrudes may be opposite to a direction in which the protrusion of the second contact portion 428d protrudes. Thus, in an assembled state of the secondary battery, an upper surface of the protrusion of the first contact portion 404d may contact a lower surface of the protrusion of the second contact portion 428d in a surface-to-surface manner such that the current collector plate 400d and the current interrupt device 420d are electrically connected.

A surface area of an upper surface or a lower surface of the protrusion may be substantially the same as described above with reference to FIG. 4.

In some embodiments, a sum of protruded lengths of the protrusion of the first contact portion 404d and the protrusion of the second contact portion 428d may be 10 mm or less. When the sum of the protruded lengths of the protrusion of the first contact portion 404d and the protrusion of the second contact portion 428d is greater than 10 mm, a total height of the battery may become too large, and the current collector plate may be difficult to manufacture through a simple process such as punching, chemical etching, roll processing, or laser processing.

In the embodiments described above with reference to FIGS. 8 and 9, the protrusion may have a circular, elliptical, or polygonal cross-section. Cross-sectional shapes of the first contact portion 404d and the second contact portion 428d may correspond to each other. For example, when a cross-section of the first contact portion 404d is circular, a cross-section of the second contact portion 428d may be circular. Thus, a surface area of contact between the first contact portion 404d and the second contact portion 428d may increase, conduction may be smoothly achieved, and internal resistance may decrease.

In the embodiments described above with reference to FIGS. 8 and 9, the current collector plates 400c, 400d include a first hole at a center of the current collector plates 400c, 400d and one or more second holes at a first distance from the center. The first contact portions 404c, 404d may be at a second distance from the center, and the second distance may be shorter than the first distance. Since the first contact portions 404c, 404d are disposed inside with respect to the centers of the current collector plates 400c, 400d and the second holes are disposed outside the first contact portions 404c, 404d, contact between the current collector plates 400c, 400d and the current interrupt devices 420c, 420d may be reliably achieved inside the current collector plates 400c, 400d. Further, gas release and/or electrolyte injection through the second holes may not be hindered by contact between the current collector plates 400c, 400d and the current interrupt devices 420c, 420d.

In the embodiments described above with reference to FIGS. 8 and 9, the current collector plates 400c, 400d may further include connection regions to which the substrate tabs are connected, and the first contact portions 404c, 404d may be alternately disposed with the connection regions about the first hole. A configuration of the connection regions and a positional relationship between the connection regions and the first contact portions may be substantially the same as the configuration of the connection region described with reference to FIG. 4 and the positional relationship between the connection region and the first fastening portion described with reference to FIG. 4.

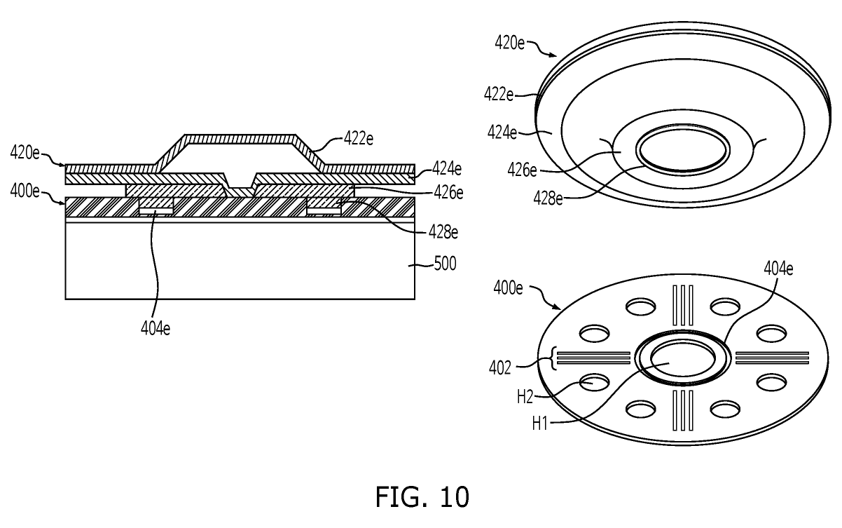

FIG. 10 is a view of a current collector plate and a current interrupt device according to an embodiment of the present disclosure. Descriptions of features in this embodiment that are the same as in the embodiments described above are omitted.

Referring to FIG. 10, in a structure having the first fastening portion and the second fastening portion, the second fastening portion 428e may have an annular shape positioned along a circumference in a lowermost surface of the current interrupt device 420e. And the first fastening portion 404e may have a shape corresponding to the second fastening portion 428e. As also illustrated in FIG. 10, the annular first fastening portion 404e may be an annular groove recessed downward. The annular second fastening portion 428e may be an annular protrusion protruding downward. By pressure or the like, the annular second fastening portion 428e having a size corresponding to the first fastening portion 404e may be fastened to the annular first fastening portion 404e. Thus, the current collector plate 400e and the current interrupt device 420e may be reliably fixed and conduction may be achieved.

In another example, the annular first fastening portion may be an annular protrusion protruding upward. The annular second fastening portion may be an annular groove recessed upward. By pressure or the like, the annular first fastening portion having a size corresponding to the annular second fastening portion may be fastened to the annular second fastening portion. Thus, the current collector plate 400e and the current interrupt device 420e may be reliably fixed and conduction may be achieved.

In a structure having the first contact portion and the second contact portion, the second contact portion may have an annular shape positioned along a circumference in a lowermost surface of the current interrupt device, and the first contact portion may have a shape corresponding to the second contact portion. For example, the annular first contact portion may include a flat portion on the same plane as an upper surface of the current collector plate, and the annular second contact portion may include a protrusion protruding downward. The protrusion of the second contact portion may contact the flat portion of the first contact portion in a surface-to-surface manner so that the current collector plate and the current interrupt device are electrically connected.

In another example, the annular first contact portion may include a protrusion protruding upward, and the annular second contact portion may include a flat portion on the same plane as a lowermost surface of the current interrupt device. The protrusion of the first contact portion may contact the flat portion of the second contact portion in a surface-to-surface manner so that the current collector plate and the current interrupt device are electrically connected.

In still another example, the annular first contact portion may include a protrusion protruding upward, and the annular second contact portion may include a protrusion protruding downward. The protrusion of the first contact portion may contact the protrusion of the second contact portion in a surface-to-surface manner so that the current collector plate and the current interrupt device are electrically connected.

A length of the annular protrusion and a surface area of an upper surface or a lower surface of the annular protrusion may be substantially the same as described above with reference to FIG. 4.

A secondary battery according to some of the embodiments described above with reference to FIGS. 6 to 10 may further include a conduction-activating member interposed between the current collector plate and the current interrupt device, as described above with reference to FIG. 4.

Although the present disclosure has been described above with respect to embodiments thereof, the present disclosure is not limited thereto. Various modifications and variations can be made thereto by those skilled in the art within the spirit of the present disclosure.

### DESCRIPTION OF SOME REFERENCE SYMBOLS

100: secondary battery

110: case

112: body

400: current collector plate

402: connection region

404: first fastening portion

420: current interrupt device

422: upper cap

422T: terminal portion

424: vent

426: lower cap

428: second fastening portion

What is claimed is:

1. A secondary battery comprising:
a case having an open upper end;
an electrode assembly accommodated in the case, the electrode assembly comprising a substrate tab;
a current collector plate connected to the substrate tab; and
a current interrupt device on the current collector plate, the current interrupt device being coupled to the upper end of the case,
wherein the current collector plate comprises a first fastening portion on an upper surface of the current collector plate that faces the current interrupt device,
wherein the current interrupt device comprises a second fastening portion on a lower surface of the current interrupt device that faces the current collector plate, and
wherein the current interrupt device is coupled to the current collector plate by fastening between the first fastening portion and the second fastening portion.

2. The secondary battery according to claim 1, wherein the first fastening portion comprises a groove recessed downward, and
wherein the second fastening portion comprises a protrusion protruding downward.

3. The secondary battery according to claim 1, wherein the first fastening portion comprises a protrusion protruding upward, and
wherein the second fastening portion comprises a groove recessed upward.

4. The secondary battery according to claim 1, wherein a first hole is formed at a center of the current collector plate and a second hole is formed in the current collector plate at a first distance from the center, and
wherein the first fastening portion is positioned at a second distance from the center, and
wherein the second distance is shorter than the first distance.

5. The secondary battery according to claim 4, wherein the current collector plate further comprises a connection region to which the substrate tab is connected, and
wherein the first fastening portion is alternately disposed with the connection region about the first hole.

6. The secondary battery according to claim 1, wherein the first fastening portion and the second fastening portion have one of circular, elliptical, or polygonal cross-sectional shape, and the cross-sectional shapes of the first fastening portion and the second fastening portion correspond to each other.

7. The secondary battery according to claim 1, wherein the second fastening portion has an annular shape positioned along a circumference in a lowermost surface of the current interrupt device, and
wherein the first fastening portion has a shape corresponding to the second fastening portion.

8. The secondary battery according to claim 2, wherein a surface area of a lower surface of the protrusion is 1% to 50% of a surface area of a lowermost surface of the current interrupt device.

9. The secondary battery according to claim 3, wherein a surface area of an upper surface of the protrusion is 1% to50 % of a surface area of an upper surface of the current collector plate.

10. A secondary battery comprising:
a case having an open upper end;
an electrode assembly accommodated in the case, the electrode assembly comprising a substrate tab;
a current collector plate connected to the substrate tab; and
a current interrupt device on the current collector plate, the current interrupt device being coupled to the upper end of the case,
wherein the current collector plate comprises a first contact portion on an upper surface of the current collector plate that faces the current interrupt device,
wherein the current interrupt device comprises a second contact portion on a lower surface of the current interrupt device that faces the current collector plate, and
wherein a surface of the first contact portion contacts a surface of the second contact portion such that the current collector plate and the current interrupt device are electrically connected.

11. The secondary battery according to claim 10, wherein the first contact portion comprises a flat portion in the same plane as the upper surface of the current collector plate, and
wherein the second contact portion comprises a protrusion protruding downward.

12. The secondary battery according to claim 10, wherein the first contact portion comprises a protrusion protruding upward, and
wherein the second contact portion comprises a flat portion in the same plane as a lowermost surface of the current interrupt device.

13. The secondary battery according to claim 10, wherein the first contact portion comprises a protrusion protruding upward, and
wherein the second contact portion comprises a protrusion protruding downward.

14. The secondary battery according to claim 10, wherein a first hole is formed at a center of the current collector plate and a second hole is formed in the current collector plate at a first distance from the center, and
wherein the first contact portion is at a second distance from the center, and
wherein the second distance is shorter than the first distance.

15. The secondary battery according to claim 14, wherein the current collector plate further comprises a connection region to which the substrate tab is connected, and
wherein the first contact portion is alternately disposed with the connection region about the first hole.

16. The secondary battery according to claim 11, wherein the protrusion has one of a circular, elliptical, or polygonal cross-sectional shape.

17. The secondary battery according to claim 11, wherein the second contact portion has an annular shape positioned along a circumference in a lowermost surface of the current interrupt device, and
wherein the first contact portion has a shape corresponding to the second contact portion.

18. The secondary battery according to claim 10, wherein the substrate tab is exposed to an upper surface of the electrode assembly,
wherein the substrate tab is bent toward a center of the electrode assembly, and
wherein the substrate tab is connected to a lower surface of the current collector plate.

19. The secondary battery according to claim 1, wherein the current interrupt device comprises:
an upper cap comprising a terminal portion protruding upward;
a vent below the upper cap and configured to burst when an internal pressure of the case exceeds a threshold value to release gas from inside the case; and
a lower cap below the vent,
wherein the lower surface of the current interrupt device that faces the current collector plate corresponds to a lower surface of the lower cap.

20. The secondary battery according to claim 1, further comprising a conduction-activating member interposed between the current collector plate and the current interrupt device,
wherein the conduction-activating member includes a conductive powder, a tape containing a conductive powder, or a combination of a conductive powder and a tape containing a conductive powder.
